(19) United States
(12) Patent Application Publication
(10) Pub. No.: US 2021/0334914 A1
(43) Pub. Date: Oct. 28, 2021

(54) SYSTEM AND METHOD FOR DETERMINING POWER PRODUCTION IN AN ELECTRICAL POWER GRID

(71) Applicant: FORESIGHT ENERGY LTD, Hod HaSharon (IL)

(72) Inventors: Emek Sadot, Ram-On (IL); Evgeny Finkel, Petah-Tikva (IL); Sergel Edelstein, Herzliya (IL); Alla Volkov, Netanya (IL)

(73) Assignee: FORESIGHT ENERGY LTD, Hod HaSharon (IL)

(21) Appl. No.: 17/367,480

(22) Filed: Jul. 5, 2021

Related U.S. Application Data
(63) Continuation-in-part of application No. 15/890,358, filed on Feb. 7, 2018, now abandoned.
(60) Provisional application No. 62/455,611, filed on Feb. 7, 2017.

(51) Int. Cl. G06Q 50/06; G06Q 30/02; G06N 20/00

(52) U.S. Cl. CPC G06Q 50/06; G06N 20/00; G06Q 30/0202

(57) ABSTRACT

Systems and methods of determining power production in an electrical power grid, with receiving of weather data for a geographical area, wherein the weather data includes values corresponding to prospective production of power from a renewable energy source, collecting power consumption data for consumers of an electrical power grid in the geographical area, identifying at least one consumer having an inverse relationship between the collected power consumption data and received weather data, assigning a power

[symbol]

### CROSS-REFERENCE TO RELATED APPLICATIONS

This application is a continuation-in-part of U.S. patent application Ser. No. 15/890,358, filed Feb. 7, 2018, which claims the benefit of U.S. Provisional Patent Application No. 62/455,611, filed Feb. 7, 2017, both of which are hereby incorporated by reference.

### FIELD OF THE INVENTION

The present invention relates to electrical power grids. More particularly, the present invention relates to systems and methods for determination and forecasting of power production in an electrical power grid.

### BACKGROUND OF THE INVENTION

In recent years, power consumption data has become available to providers (e.g. power plants) utilizing “smart” power consumption meters. These power consumption meters are usually directly coupled to a consumer, for instance coupled to a power grid of a private household, such that the power provider may at any time retrieve data from the meters, for instance retrieve power consumption data via a communication network.

While a vast amount of power consumption data is available, there is still a need for a way to manage all of this data to determine power consumption and power production in electrical power grids.

### SUMMARY OF THE INVENTION

There is thus provided, in accordance with some embodiments of the invention, a method of determining power production in an electrical power grid, the method including receiving, by a processor, weather data for a geographical area, wherein the weather data includes values corresponding to prospective production of electrical power from a renewable energy source; collecting, by the processor, power consumption data for consumers of an electrical power grid in the geographical area; identifying, by the processor, at least one consumer having an inverse relationship between the collected power consumption data and the received weather data; assigning, by the processor, a power production value to the identified consumers, based on a comparison between the collected power consumption data and the received weather data; determining total power production in the electrical power grid for all identified consumers; comparing the power consumption data to the received weather data; determining the type of renewable energy source based on a correlation between power consumption and weather data for the same time period; training, by the processor, a machine learning (ML) algorithm to identify patterns of power production at the geographical area; and providing, by the processor, energy saving recommendations for all identified consumers based on the power production value, based on a weather data forecast, based on the determined type of renewable energy source, and based on a power production forecast generated by the ML algorithm, wherein the energy saving recommendations comprise at least one of: maintenance recommendation or recommendation for power consumption optimization.

In some embodiments, the energy saving recommendations may be provided based on the power production value. In some embodiments, the energy saving recommendations may be based on weather data forecast. In some embodiments, the energy saving recommendations may be based on at least one of socio-economic status and average power consumption values for a group of consumers in a predefined geographical area. In some embodiments, the energy saving recommendations may be based on at least one of records of past power consumption, peak power consumption, and electrical power rates. In some embodiments, the energy saving recommendations may include recommendations to install a power production system.

In some embodiments, the identification of consumers may be based on correlation between weather data to the geographical location of the consumer relative to the electrical power grid. In some embodiments, the collected power consumption data may be received from at least one smart meter associated with at least one consumer.

There is thus provided, in accordance with some embodiments of the invention, a system for determination of power production in an electrical power grid, the system including a first database including power consumption data for at least one consumer of an electrical power grid, a second database including weather data for a geographical area corresponding to the electrical power grid, and a processor, operationally coupled to the first database and to the second database. In some embodiments, the processor may be configured to identify at least one consumer having an inverse relationship between the power consumption data and the weather data.

In some embodiments, the first database may include information regarding at least one of socio-economic status and average power consumption values for a group of consumers in a predefined geographical area. In some embodiments, the second database may include weather data forecast. In some embodiments, the weather data may include values corresponding to prospective production of electrical power from a renewable energy source. In some embodiments, power consumption data from consumers may be received from one or more smart meter associated with the at least one consumer.

In some embodiments, the system may further include a memory unit to store at least on of weather data and power consumption data. In some embodiments, the system may further include a renewable energy source database including types of renewable energy sources.

There is thus provided, in accordance with some embodiments of the invention, a method of forecasting power production in an electrical power grid, the method including collecting, by a processor, power consumption data for consumers of an electrical power grid in a geographical area, with corresponding weather data including values corresponding to prospective production of electrical power from a renewable energy source; detecting, by the processor, at least one consumer having an inverse relationship between the collected power consumption data and a parameter in the weather data; determining power production in the electrical power grid for each identified consumer; and determining, by the processor, power production forecast based on a correlation between power consumption and a parameter in weather data for the same time period.

In some embodiments, energy saving recommendations may be provided based on the power production value. In some embodiments, energy saving recommendations may be based on at least one of records of past power consumption, peak power consumption, and electrical power rates. In some embodiments, the energy saving recommendations may include recommendations to install a power production system. In some embodiments, calculation of power production forecasting may be based on aggregation of consumption and production in each geographical location of the consumer relative to the electrical power grid.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2 schematically illustrates a system for determination of power production in an electrical power grid, according to some embodiments of the invention;

FIG. 3A shows a flowchart of a method of determining power production in an electrical power grid, according to some embodiments of the invention;

FIGS. 3B and 3C show a continuation of the flowchart from FIG. 3A, according to some embodiments of the invention;

FIG. 4A shows a flowchart of a method of determining power production in an electrical power grid, according to some embodiments of the invention; and

FIG. 4B shows a continuation of the flowchart from FIG. 4A, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

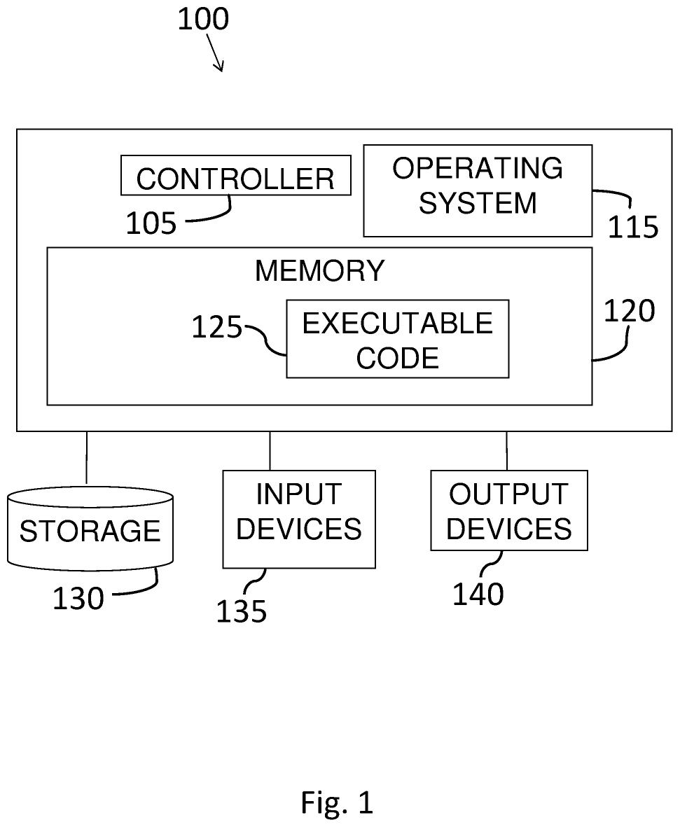

Reference is made to FIG. 1, showing a block diagram of an exemplary computing device, according to some embodiments of the present invention. Computing device 100 may include a controller 105 that may be, for example, a central processing unit processor (CPU), a chip or any suitable computing or computational device, an operating system 115, a memory 120, a storage 130, an input devices 135 and an output devices 140. Controller 105 may be configured to carry out methods as disclosed herein by for example executing code or software.

Operating system 115 may be or may include any code segment designed and/or configured to perform tasks involving coordination, scheduling, arbitration, supervising, controlling or otherwise managing operation of computing device 100, for example, scheduling execution of programs. Operating system 115 may be a commercial operating system. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units.

Executable code 125 may be any executable code, e.g., an application, a program, a process, task or script. Executable code 125 may be executed by controller 105 possibly under control of operating system 115. For example, executable code 125 may be an application for managing power consumption data. Where applicable, executable code 125 may carry out operations described herein in real-time. Computing device 100 and executable code 125 may be configured to update, process and/or act upon information at the same rate the information, or a relevant event, are received. In some embodiments, more than one computing device 100 may be used. For example, a plurality of computing devices that include components similar to those included in computing device 100 may be connected to a network and used as a system. For example, managing power consumption data may be performed in real time by executable code 125 when executed on one or more computing devices such computing device 100.

Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in storage 130 and may be loaded from storage 130 into memory 120 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a modem, printer or facsimile machine, a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, cause the processor to carry out methods disclosed herein. For example, some embodiments of the invention may include a storage medium such as memory 120, computer-executable instructions such as executable code 125 and a controller such as controller 105.

A computer or processor non-transitory storage medium, may include for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

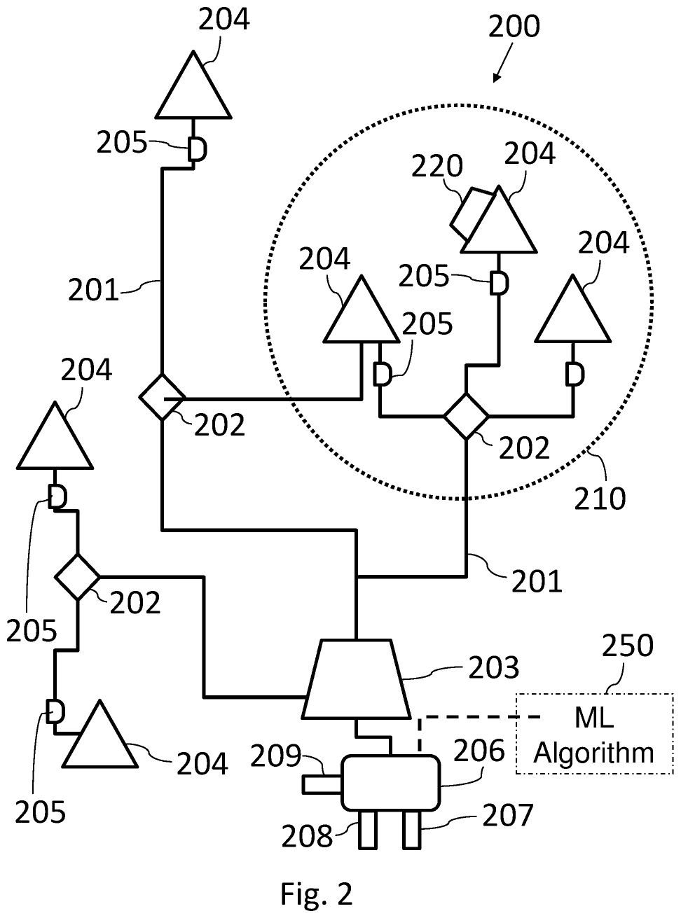

Reference is now made to FIG. 2, which schematically illustrates a system 200 for determination and forecasting of power production in an electrical power grid 201, according to some embodiments of the invention. In some embodiments, it may be possible to detect which consumers produce power by correlating historical data on consumed energy from the electrical power grid, by reducing the produced energy from the total consumed energy, as further described hereinafter.

According to some embodiments, forecasting of power consumption and/or production may be carried out with machine learning algorithms 250, as further described hereinafter. Such algorithms that are based on supervised machine learning principles may utilize historical data of real power consumption values of the consumer and/or using auxiliary data for the training stage. Historical weather data may be real weather data, whereas the data used for prediction is the received weather forecast (e.g., including a weather forecast error). In some embodiments, the training of machine learning models may be carried out while taking into account the weather forecast error.

Power production determination system 200 may include an electrical power grid 201 with a plurality of electrical power nodes 202 (or electrical power transformation centers) that receive power from a central electrical power distributor 203. Each electrical power node 202 may be configured to provide electrical power, via electrical power grid 201, to at least one consumer 204 (e.g., a private household or an office building). Power distributer 203 (e.g., a local power plant) may distribute electrical power, via electrical power grid 201, to electrical power nodes 202 and thereby to consumers 204.

According to some embodiments, electrical power grid 201 may have (e.g., smart) power consumption meters 205, which measure power consumption of at least one consumer 204 that is coupled thereto, so as to allow monitoring of the power consumption of consumers 204. In some embodiments, power consumption meters 205 may also be configured to allow communication with at least one analysis computerized device 206 (or central processor), for instance operably coupled to power distributer 203.

Some consumers in the power grid 201 may have their own alternative sources of energy (in addition to the power grid 201) that cover part of the total electricity consumption. As a result, the power consumption meters 205 may not determine the total consumption, but the amount of energy consumed from the external network (e.g., the network load). Thus, prediction and optimization of the network load may correspond to the unknown volume of power production from the unknown power source (e.g., a solar panel).

In some embodiments, computerized device (or processor) 206 may be a computing device 100 (such as shown in FIG. 1) with corresponding processing and memory elements configured to allow analyzing and processing of aggregated data from all consumers 204. It should be appreciated that via the coupling to power distributer 203, the analysis computerized device 206 may be operationally coupled to at least two electrical power nodes 202.

It should be appreciated that communication with computerized device 206 may be carried out via a wireless network and/or via communication cables (for instance adjacent to electrical power grid 201). In some embodiments, different power consumption meters 205 may communicate with computerized device 206 via different networks, for instance a wired network and a cellular network.

According to some embodiments, power production determination system 200 may include a dedicated power consumption database 207, operably coupled to computerized device 206, including data for at least one consumer 204. In some embodiments, each consumer 204 may have a user profile indicating typical power consumption of that user, for instance based on previous power consumption records from power consumption database 207. Thus, data received for that consumer 204 (e.g., from consumption meters 205) may be compared to the user profile in order to detect changes in power consumption. In some embodiments, power consumption database 207 may also have information with calendar data, for example, where people on national holiday for instance may use more electrical devices compared to weekdays where people are usually at work during the day. In some embodiments, calendar data may be stored in a separate dedicated database.

In some embodiments, each consumer 204 may have a user profile with selected dates (e.g., selected days) of the calendar data where power consumption and/or power production is expected to be significantly different. For example, a consumer 204 may select a specific date expecting low power production (e.g., due to infrastructure maintenance) or high power consumption (e.g., due to a party with many people in the same household) such that power recommendations may be accordingly modified.

In some embodiments, power production determination system 200 may further include a dedicated ambient condition database 208 and a renewable energy source database 209, operably coupled to computerized device 206. For example, on a cold day, more heaters may be turned on, thereby increasing overall power consumption. Ambient condition database 208 may include information for weather conditions in a predefined geographical area 210 (indicated with a dashed line) corresponding to the electrical power grid 201. In some embodiments, weather data from ambient condition database 208 may include values corresponding to prospective or future production of electrical power from a renewable energy source. For example, specific solar illumination intensity may correspond to a known power production with solar panels (e.g., determined during calibration). In some embodiments, ambient condition database 208 may further include information for a weather forecast. In some embodiments, ambient condition database 208 may further include information regarding physical properties of the consumer 204, for example available space to install a solar panel and/or a wind turbine 220.

In the example with solar panels, photovoltaic energy may be generated by solar panels that convert solar irradiance into electricity. The main factors for generating electricity may be the amount of solar irradiance received at the plane of the solar panel (e.g., per hour), and/or the angle of incidence, and/or the ambient temperature, and/or the temperature of the solar panel, and/or cloudiness that may block the solar irradiance, and/or humidity, and the like. The maximum value of the generated energy may be determined by the characteristics of the specific solar panel (for example, the maximum generation capacity). Accordingly, it may be possible to predict or forecast the future generation of electricity by the solar panels, by defining the main patterns and features of the influence of ambient weather conditions taking into account the particular characteristics of the solar panel.

It should be appreciated that, in an area having smart power consumption meters within a predetermined geographical zone (e.g., determined for each central electrical power distributor 203), neighboring consumers may present similar power consumption behavior (e.g. for families from similar socio-economic levels), such that these consumers may be grouped based on their power consumption, for instance grouped within a street, a portion of a street, a neighborhood or even within a city. In some embodiments, a general power consumption and/or production pattern may be learned and accordingly applied to different geographical areas (e.g., having similar weather conditions).

Renewable energy source database 209 may include information for various types of systems 220 for power production from renewable energy sources, such as solar panels, wind turbines, etc. In some embodiments, renewable energy source database 209 may further include typical power production values for each type, for example typical power production values for a solar panel 220 for a particular geographical area 210 having clear skies enabling full illumination of the panels (e.g., data from a calibrated external source).

In some embodiments, all meters in electrical power grid may be sampled in order to identify a source of nearly pure production 220 where power consumption is minimal, in order to forecast power production of such a system 220 in the future. For example, power production determination system 200 may include a solar panel 220 that may produce power in an empty household 204 where no one consumes power from the electrical power grid, as a source of nearly pure production 220. It may, therefore, be possible to provide recommendations of installing a similar power production system 220 (knowing possible power production for such a system) to consumers 204 having similar conditions (e.g., being in the same geographical area 210, having similar physical characteristics and the like).

To improve forecasting of total power consumption, pre-trained machine learning models may be used to predict the production of energy from renewable sources (e.g., using solar panels), taking into account the location, and/or weather data and/or characteristics of the power production facility. Adding the predicted value of electricity generation to the data on the network load, may accordingly determine the accurate value of power consumption by a specific consumer.

According to some embodiments, computerized device 206 may identify at least one consumer having an inverse relationship between the power consumption data (from power consumption database 207) and the weather data (from ambient condition database 208). Consumers identified as having an inverse relationship may be determined to produce electrical power from renewable energy sources, with a renewable energy power production system 220.

In some embodiments, data from consumers determined to produce electrical power from renewable energy sources may be compared to data from renewable energy source database 209 so as to determine at least one type of renewable energy source used to produce the power. For example, computerized device 206 may determine that a particular consumer has solar panels and/or a wind turbine to produce electrical power.

In some embodiments, consumers 204 identified as having a power production system 220 may receive recommendation to install an additional power production system 220 in order to increase the power production. For example, a consumer 204 having a wind turbine may receive recommendations to install a solar panel and/or an additional wind turbine to increase the power production.

In some embodiments, power consumption for consumers 204 identified as having a power production system 220 may be further analyzed (e.g., by computerized device 206) to identify a reduction in power production with time (e.g., due to dust collected on a solar panel). Upon detection of such a reduction in power production with time, system 200 may provide maintenance recommendation to the consumer 204.

In some embodiments, computerized device 206 may associate power consumption data for a particular consumer 204 to similar consumers, by comparison to other consumers so as to allow prediction of expected power production (e.g., from power consumption database 207) at a similar period of time, for example in a previous month, prior to suspected installation of power generator (e.g., a solar panel). In some embodiments, computerized device 206 may associate and/or cluster consumer power consumption data with consumption data of other similar consumers 204, based on at least one of the following parameters: being in the same geographical area 210 and/or having similar socio-economic state and/or having similar average power consumption during the hours when generation from renewable sources is ineffective (e.g., during night for solar panels).

In some embodiments, false identification of consumers 204 having power production systems 220, may be reduced by correlating power production to actual ambient conditions (such as illumination or wind conditions). In some embodiments, false identification of consumers 204 having power production systems 220, may be reduced by comparison to other consumers 204 in a benchmark group and/or comparison to previous power consumption in a previous time period (e.g., prior to identification of a power production system).

According to some embodiments, the power consumption meters 205 may measure total net load by the consumer 204, as the difference between the power consumption of the consumer 204 and for instance power produced by a renewable energy source (e.g., a solar panel) that is coupled thereto, since direct power production and power consumption measurements are not available.

According to some embodiments, the power production determination system 200 may allow automatic identification of candidates for power production based on at least one of recorded consumption patterns, geographical conditions and roof prerequisites, for instance while applying machine learning algorithms 250. In some embodiments, power production determination system 200 may dynamically segment consumers 204 to identify behavior patterns so as to optimize forecasting of power production and/or forecasting of power consumption, for example computerized device 206 may disintegrate consumption to base load, weather dependent and flexible load and analyze correlations thereof. In some embodiments, geographical aggregation of power production and/or power consumption may be applied to determine net load in each geographical point. In some embodiments, at least one known pattern of power production (e.g., using a solar panel) may be sufficient to learn other patterns (e.g., using machine learning algorithms 250) and accordingly optimize forecasting.

It should be noted that in comparison to typical solutions that are based on statistical estimates of power production or consumption in each season of the year, the power production determination system 200 may allow dynamic point-by-point analysis of end-user historical and/or forecasted power consumption and/or historical and/or forecasted power production in order to generate accurate recommendations for installation of a power production system. Moreover, the generated recommendations may be applied on a set of locations where no existing power production facilities were identified, for example provide recommendations for a consumer without a power production facility to install such facility in a predetermined location (e.g., on the roof).

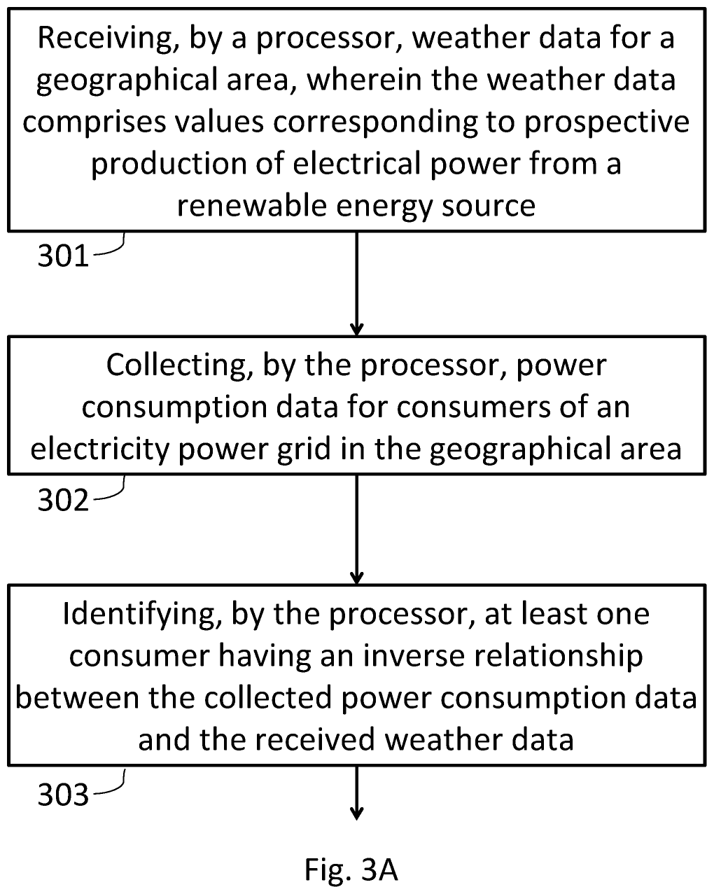

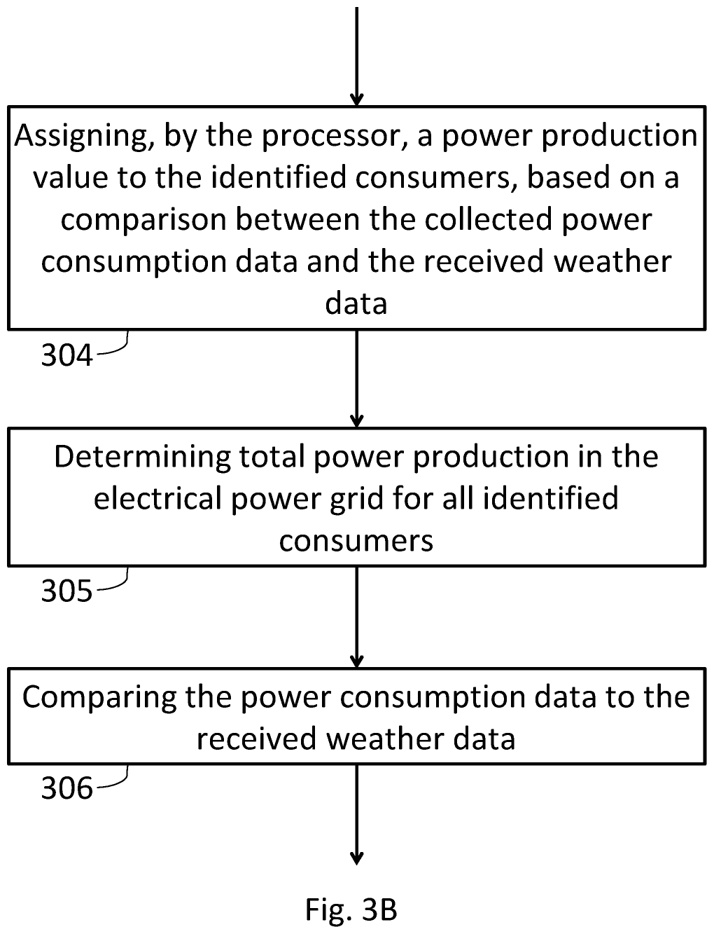

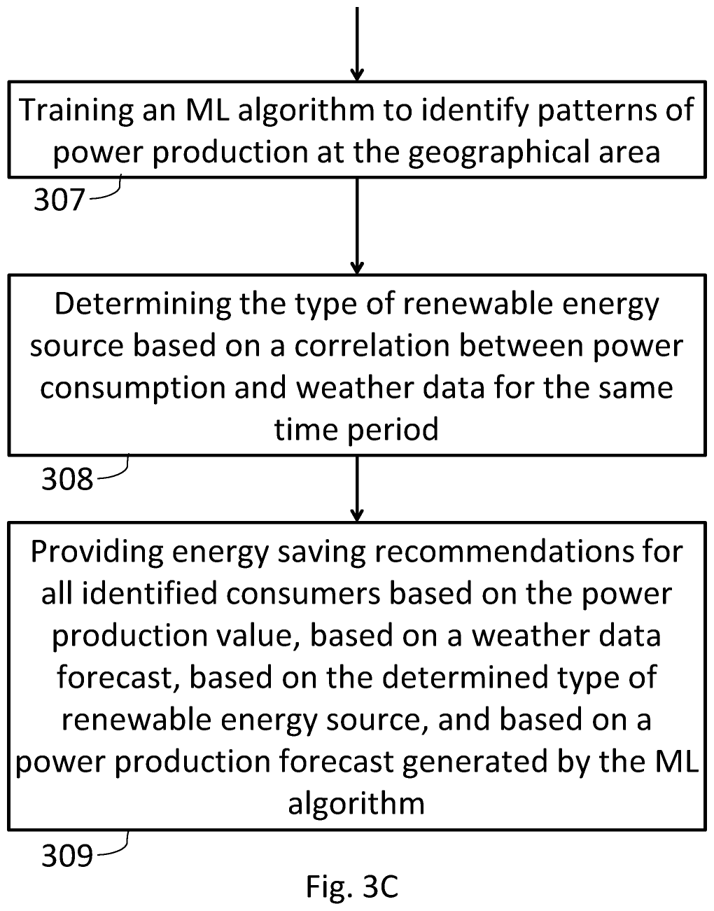

Reference is now made to FIGS. 3A-3C, which show a flowchart of a method of determining power production in an electrical power grid, according to some embodiments of the invention. Some embodiments may include receiving or collecting 301, by the processor 206, weather data for a predetermined geographical area 210 such that this area only includes consumers 204 of interest, wherein the weather data includes weather values such as temperature, solar illumination intensity, wind speed, pressure, rain amount, where the weather values correspond to values prospective or future production of electrical power from a renewable energy source (e.g., stored in a separate database), for example specific solar illumination intensity may correspond to a known power production with solar panels (e.g., determined during calibration).

Some embodiments may include receiving or collecting 302, by the processor 206, power consumption data for consumers 204 of an electrical power grid 201 in the predetermined geographical area 210. Some embodiments may include collecting data for at least one consumer 204 of the electrical power grid 201. For example, the collected data may include a received electrical power grid layout (or topology) and consumer 204 data. For example, data may be collected (e.g., from smart meters) to determine which consumer 204 is coupled to which power node 202 where the determination (of which consumer 204 is coupled to which power node 202) may be based on consumer parameters such as geographical position and social value.

In some embodiments, the collected data may have information regarding at least one of weather conditions at a predefined geographical area (e.g. a city), socio-economic status of consumers in the area, power consumption data for the one or more consumers in the area, and average power consumption values for a group of consumers in the predefined geographical area.

Some embodiments may include identifying 303, by the processor 206, at least one consumer 204 having an inverse relationship between the collected power consumption data and the received weather data. For example, one embodiment may detect a decrease in power consumption (e.g., collected from a smart meter) at a time of high solar illumination conditions. In some embodiments, the identification of consumers 204 may include associating each consumer 204 to a consumption group, according to one or more attributes of each consumer 204, wherein at least one consumer 204 in each group may be connected to a smart meter. In some embodiments, the identification of consumers 204 may include comparing power consumption data for a particular consumer at different time periods.

Some embodiments may include assigning 304, by the processor 206, a power production value (e.g., a general unit-less value) to identified consumers 204 as an indicator of power production, based on a comparison between the collected power consumption data and the received weather data. Some embodiments may include determining 305 total power production in the electrical power grid 201 for all identified consumers 204.

Some embodiments may include comparing 306 the power consumption data to the received weather data. Some embodiments may include training 307 a machine learning algorithm to identify patterns of power production at the geographical area. Once the ML algorithm is trained, it may be utilized to optimize the forecasting of power production and/or power consumption. Some embodiments may include determining 308 the type of renewable energy source based on a correlation between power consumption and weather data for the same time period.

Some embodiments may include providing energy saving recommendations based on the power production value. In some embodiments, the energy saving recommendations may also be based on weather data forecast, for example recommend operating devices with high power consumption (e.g., washing machine) during time periods of potentially high power production from a renewable energy source (e.g., during high illumination time periods for solar panels). In some embodiments, the energy saving recommendations may also be based on at least one of socio-economic status and average power consumption values for a group of consumers in a predefined geographical area. In some embodiments, the energy saving recommendations may also be based on records of past power consumption and/or peak power consumption and/or electrical power rates.

In some embodiments, the energy saving recommendations may also be based on analysis of current power consumption, with forecasting of future power production, and providing a recommendation to install a power production system. For example, processor 206 may identify a consumer with time periods of high illumination (e.g., for a solar panel) and/or strong winds (e.g., for a wind turbine) and recommending to install a suitable power production system.

Some embodiments may include comparing the power consumption data to the received weather data, and determining the type of renewable energy source based on correlation between power consumption and weather data for the same time period. For example, an embodiment may receive power consumption data from a calibrated external power source (e.g., a solar panel with known power production for specific illumination values) to determine a renewable energy source type that is compatible with the measured weather data. In some embodiments, the identification of consumers may be based on correlation between weather data to the geographical location of the consumer relative to the electrical power grid. As may be apparent to one of ordinary skill in the art, such determination of renewable energy source type may in some embodiments not require previous knowledge of existing systems allowing power production from renewable energy sources, for instance in the predetermined geographical area 210.

Some embodiments may include storing at least one of weather data and power consumption data on a memory unit. In some embodiments, the collected power consumption data may be received from at least one smart meter 205 associated with at least one consumer 204. Some embodiments of the present invention may allow consumers in a power grid with renewable energy power sources to be identified, such that recommendation for power consumption optimization may be created based on the types of the renewable energy sources, and thereby save power compared to existing methods where such recommendations cannot be created.

According to some embodiments, at least one machine learning (ML) algorithm is utilized in order to optimize the forecasting of power consumption and/or production. The input for such ML algorithms 205 may include weather data and/or data of power production facilities. The main regularities of the influence of weather conditions on the energy generation from the power production facilities may be the same for all types of power production facilities, while being adjusted for the characteristics of the particular power production facility associated with a particular consumer, when the data is scaled. For example, characteristics of the power production facilities may include the maximum capacity, the angle of inclination of a solar panel, the dynamic movement of the solar panel following the sun, etc.

For scaling, dividing the power generation values by the maximum plant capacity may be used, and the generation data from various sources may be in the interval from 0 to 1.

Accordingly, the use of generation data obtained from several sources may allow training a supervised ML model better than training on separate devices, and may also allow using these models to predict power production for those devices for which there is no historical power consumption data for training a separate model.

There are two types of generalized ML models: a model trained on data from known power production facilities (e.g., solar panels) of one geographic zone (e.g., a city, a region, a small country, etc.), in which the weather conditions are similar, as a “local model”, and a model trained on data from all globally known power production facilities (e.g., solar panels) where weather trends may vary, as a “global model”. In some embodiments, the general model, although lacking knowledge of local patterns, may be used for those power production facilities (e.g., solar panels) for which there are no local models.

According to some embodiments, data from different sources (e.g., solar panels) may be scaled and combined. Thus, a set of supervised ML models (e.g., regression type) may be trained on the whole set of data including: scaled power production facility energy generation value as a target value, and/or weather conditions data, and/or for solar panels the solar position and the angle between a solar panel plane and solar light.

The weather conditions data may correspond to each value of generated energy (e.g., weather characteristics for each individual record of generated energy for each individual device, respectively) as features. The data may be shuffled and split into three parts: the training part, which is used for ML model training, the validation part, which is used for ML models hyperparameters tuning, and the testing part, which is used for ML model performance estimation.

In some embodiments, ML models used during a training step may include: an XGBoost regression model, and/or a random forest regression model, and/or a linear regression model. After all models are trained and tuned, the linear regression model may be used for combining the results of all models into one and weighting their impacts, for instance as ensembling. Taking into account the fact that there are two types of received weather data (e.g., real data and forecast data), two ensembles of models may be created, with one based on real data (as “in” type), and another one based on forecast data (as “out” type).

According to some embodiments, since the weather data is divided into a real historical part and an assumed forecasted part, the two generated ML models (“in” and “out”) may be used to predict latent energy production, taking into account the type of location (e.g., local or general model). A set of historical weather data corresponding to a specific location of a predictable source may be fed to the input of the selected pair of models (“in” and “out”). The dataset may also match the set used to train these ML models (for example, humidity data may not be used to build the model, and accordingly should be excluded from the current set as well), the value units should also match (e.g., using degrees with Celsius). Thus, the output from the ML models may be scaled (from 0 to 1) values of the calculated energy production for the entire training and forecasting periods. The scaled values may accordingly be multiplied by the maximum capacity of the given energy source and the actual calculated data may thus be obtained.

According to some embodiments, the obtained values of power generation (“in” model) are added to the historical net load data, where the results may describe the power consumption of the consumer. A set of supervised ML models (e.g., regression type) may be trained on the whole set of data including: power consumption data for the entire historical period as a target value, and/or weather conditions data corresponding to each value of consumed energy (e.g., weather characteristics for each individual record of consumed energy, and/or day types data (e.g., if the timestamp belongs to holiday or workday, etc.), and/or data shifts (e.g., data for previous day, week etc.) to include knowledge of recent periods.

The data may be shuffled and split into three parts: the training part, which is used for models training, the validation part, which is used for models hyperparameters tuning, and the testing part, which is used for model performance estimation. Machine learning models used during a training step may be: XGBoost regression model, random forest regression model, mixed tree regression model, naive statistical models, and linear regression model. After all ML models are trained and tuned, the ordinary linear regression model may be used for combining the results of all models into one and weighting their impacts (ensembling).

In some embodiments, after the ensemble of ML models is trained, it may be used for power consumption forecasts for a predefined period, where the calculated power generation data for the forecast period (“out” model) may be deducted from forecasted consumption values. Thus, the forecasted net load data may be obtained.

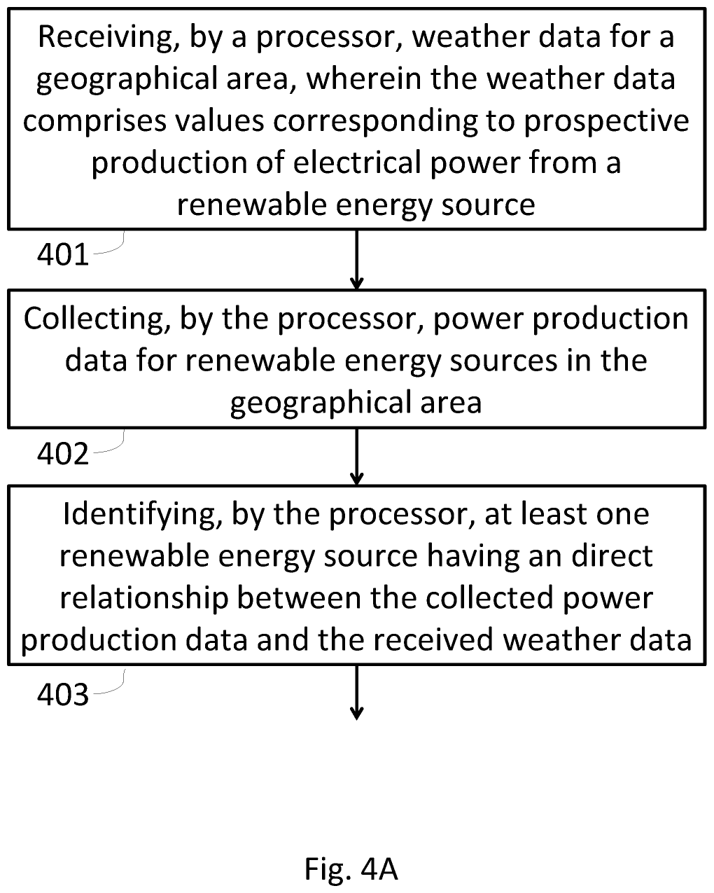

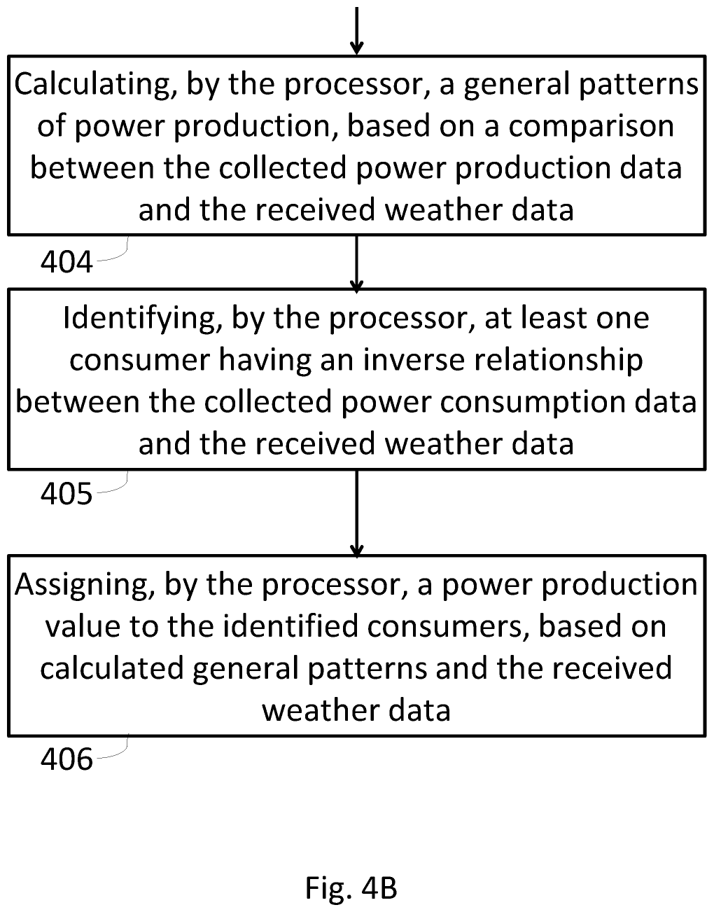

Reference is now made to FIGS. 4A and 4B, which show a flowchart of a method of determining power production, according to some embodiments of the invention.

Some embodiments may include receiving or collecting 401, by the processor 206, weather data for a predetermined geographical area 210, wherein the weather data includes weather values such as temperature, solar illumination intensity, wind speed, pressure, amount of rain, where the weather values correspond to values of historical or past production of electrical power from a renewable energy source and values prospective or future production of electrical power from a renewable energy source (e.g., stored in a separate database), for example specific solar illumination intensity may correspond to a known power production with solar panels (e.g., determined during calibration).

Some embodiments may include receiving or collecting 402, by the processor 206, power production data from smart meters associated with renewable energy sources 220 in the predetermined geographical area 210. Some embodiments may include collecting data for at least one smart meter associated with at least one renewable energy source. For example, the collected data may include a received electrical power grid layout (or topology) and data for a smart meter associated with solar panels.

In some embodiments, the collected data may have information regarding at least one of the weather conditions at a predetermined geographical area 210 (e.g., in a city), renewable energy sources parameters data (e.g. maximum power production capacity), and power production data for the one or more renewable energy sources in the area.

Some embodiments may include identifying 403, by the processor 206, at least one renewable energy source 220 having a direct relationship between the collected power production data (e.g., a general unit-less value) and the received weather data in the particular geographic area. For example, one embodiment may detect a decrease in power production (e.g., collected from a smart meter) at a time of low solar illumination conditions.

In some embodiments, computerized device 206 may associate power production data for a particular renewable energy source 220 to received weather data so as to allow prediction of expected power production (e.g., from renewable energy source database 209) at a similar period of time or weather conditions, for example for the period with similar solar illumination conditions.

In some embodiments, computerized device 206 may calculate solar position (e.g., solar azimuth and solar altitude) for a particular timestamp for a particular geographic zone. In some embodiments, computerized device 206 may associate power production data for a particular renewable energy source (e.g., for solar panel) 220 to calculated solar position so as to allow prediction of expected power production (e.g., from renewable energy source database 209).

In some embodiments 404, computerized device 206 may associate power production data for all renewable energy sources (e.g. solar panels) 220 in a particular geographic area to received weather data so as to obtain a set of patterns between power production and weather conditions in particular geographic area 210. For example, one embodiment may associate data for all solar panels in one particular city to received weather data in the same city. Each renewable energy source 220 may have a device profile indicating maximum power production capacity of that device. Thus, data received for all renewable energy sources 220 (e.g., from smart meters 205) should be scaled by maximum power production capacity in order to compare data for different renewable energy sources.

In some embodiments 404, computerized device 206 may associate power production data for all renewable energy sources (e.g., solar panels) 220 in all geographic areas to received weather data so as to obtain a set of patterns between power production and weather conditions. For example, one embodiment may associate data for all known solar panels to received weather data. Each renewable energy source 220 may have a device profile indicating maximum power production capacity of that device. Thus, data received for all renewable energy sources 220 (e.g., from smart meters 205) should be scaled by maximum power production capacity in order to compare data for different renewable energy sources.

Some embodiments may include identifying 405, by the processor 206, at least one consumer 204 having renewable energy source 220 hidden by the total net load meter 205 in a particular geographic area 210 (e.g., city) having an invert relationship between the collected power consumption data and the received weather data. For example, one embodiment may detect a decrease in power consumption (e.g., collected from a smart meter) at a time of high solar illumination conditions.

Some embodiments of the present invention may allow consumers in a power grid with renewable energy power sources to be identified, such that the prediction of power production may be provided based on calculated set of patterns between power production data and weather data for particular geographic area, as well as the recommendation for power consumption optimization may be created based on predicted power production, and thereby save power compared to existing methods where such recommendations cannot be created.

In some embodiments 406, computerized device 206 may assign power production data for consumers 204 having at least one renewable energy source 220 hidden by the total net load meter 205 in particular geographic area 210 based on received weather data and calculated set of patterns between power production data and weather data for particular geographic area.

Some embodiments may include storing at least one of calculated patterns set between power production data and weather data on a memory unit. In some embodiments, the calculated general patterns data may be associated with particular geographical location (e.g., within a city).

Some embodiments of the present invention may allow consumers in a power grid with renewable energy power sources to be identified, such that recommendation for power consumption optimization may be created based on the predicted power production values of the renewable energy sources, and thereby save power compared to existing methods where such recommendations cannot be created.

Unless explicitly stated, the method embodiments described herein are not constrained to a particular order in time or chronological sequence. Additionally, some of the described method elements can be skipped, or they can be repeated, during a sequence of operations of a method.

Various embodiments have been presented. Each of these embodiments may of course include features from other embodiments presented, and embodiments not specifically described may include various features described herein.

1. A method of determining power production in an electrical power grid, the method comprising:
receiving, by a processor, weather data for a geographical area, wherein the weather data comprises values corresponding to prospective production of electrical power from a renewable energy source;
collecting, by the processor, power consumption data for consumers of an electrical power grid in the geographical area, wherein the collected power consumption data is received from at least one smart meter associated with at least one consumer;
identifying, by the processor, at least one consumer having an inverse relationship between the collected power consumption data and the received weather data;
assigning, by the processor, a power production value to the identified consumers, based on a comparison between the collected power consumption data and the received weather data;
determining, by the processor, total power production in the electrical power grid for all identified consumers;
comparing, by the processor, the power consumption data to the received weather data;
determining, by the processor, the type of renewable energy source based on a correlation between power consumption and weather data for the same time period;
training, by the processor, a machine learning (ML) algorithm to identify patterns of power production at the geographical area; and
providing, by the processor, energy saving recommendations for all identified consumers based on the power production value, based on a weather data forecast, based on the determined type of renewable energy source, and based on a power production forecast generated by the ML algorithm, wherein the energy saving recommendations comprise at least one of: maintenance recommendation or recommendation for power consumption optimization.

2. The method of claim 1, wherein the energy saving recommendations are based on at least one of socio-economic status or average power consumption values for a group of consumers in a predefined geographical area.

3. The method of claim 1, wherein the energy saving recommendations are based on at least one of records of past power consumption, peak power consumption, or electrical power rates.

4. The method of claim 1, wherein the energy saving recommendations comprise recommendations to install a power production system.

5. The method of claim 1, wherein the identification of consumers is based on correlation between the weather data to the geographical location of the consumer relative to the electrical power grid.

6. The method of claim 1, further comprising:
determining, by the processor, at least one power production pattern for renewable energy sources in the predetermined geographical area, based on a comparison between the collected power generation data and the received weather data; and
assigning, by the processor, a power generation value to the identified consumers, based on the comparison between determined power production patterns and the received weather data in the predetermined geographical area.

7. A system for determination of power production in an electrical power grid, the system comprising:
a first database comprising power consumption data for at least one consumer of an electrical power grid;
a second database comprising weather data for a geographical area corresponding to the electrical power grid; and
a processor, operationally coupled to the first database and to the second database, wherein the processor is configured to:
identify at least one consumer having an inverse relationship between the power consumption data and the weather data;
assign a power production value to the identified consumers, based on a comparison between the power consumption data and the weather data;
determine total power production in the electrical power grid for all identified consumers;
determine the type of renewable energy source based on a correlation between power consumption and weather data for the same time period;
train a machine learning (ML) algorithm to identify patterns of power production at the geographical area; and
provide energy saving recommendations for all identified consumers based on the power production value, based on the determined type of renewable energy source, and based on a power production forecast generated by the ML algorithm, wherein the energy saving recommendations comprise at least one of: maintenance recommendation or recommendation for power consumption optimization.

8. The system of claim 7, wherein the first database comprises information regarding at least one of socio-economic status or average power consumption values for a group of consumers in a predefined geographical area.

9. The system of claim 7, wherein the weather data comprises values corresponding to prospective production of electrical power from a renewable energy source.

10. The system of claim 7, further comprising a memory unit to store at least one of weather data or power consumption data.

11. The system of claim 7, further comprising a renewable energy source database comprising types of renewable energy sources.
